(19) United States
(12) Patent Application Publication
(10) Pub. No.: US 2014/0215901 A1
(43) Pub. Date: Aug. 7, 2014

(54) Bed Bug Control Devices, Systems and Methods Using Heat and Volatile Insecticides

(71) Applicants: Philip G. Koehler, Gainesville, FL (US); Roberto M. Pereira, Gainesville, FL (US); Margaret Lehnert, Kent, OH (US); Amon Wayne Walker, Hawthorne, FL (US)

(72) Inventors: Philip G. Koehler, Gainesville, FL (US); Roberto M. Pereira, Gainesville, FL (US); Margaret Lehnert, Kent, OH (US); Amon Wayne Walker, Hawthorne, FL (US)

(73) Assignee: University of Florida Research Foundation, Inc., Gainsvlle, FL (US)

(21) Appl. No.: 14/186,282

(22) PCT Filed: Aug. 24, 2012
(86) PCT No.: PCT/US2012/052309

§ 371 Date: Feb. 21, 2014

Related U.S. Application Data
(60) Provisional application No. 61/527,766, filed on Aug. 26, 2011.

(51) Int. Cl. A01M 1/20; A01M 13/00

(52) U.S. Cl. CPC A01M 1/2072; A01M 1/2061; A01M 13/003; A01M 1/2077
USPC 43/131

(57) ABSTRACT

Devices, apparatus, systems and methods of volatizing insecticide-impregnated strips, such as a dichlorvos resin strip, using heat that can treat a closed and sealed space unit such as a room or building for bed bugs and other undesirable insects. At least one volatile impregnated strip can be positioned in a cage sandwiched between heating members such as electrical heating elements and heated plates. Temperature and time for heating can be controlled. Fans and blowers can help circulate the volatized air so that occupants can return safely to use the space unit within approximately 24 to approximately 36 hours.

This application is based on Patent Cooperation Treaty Application PCT/US2012/052309 filed Aug. 24, 2012, which claims the benefit of priority to U.S. Provisional Patent Application Ser. No. 61/527,766 filed Aug. 26, 2011. The entire disclosure of each of the applications listed in this paragraph are incorporated herein by specific reference thereto.

### FIELD OF INVENTION

This invention relates to dispensing of insecticides and pesticides, in particular to devices, apparatus, systems and methods of volatizing insecticides impregnated into resin strips with heat from heating members which is then exhausted into a room space to be treated for bed bugs and other insects.

### BACKGROUND AND PRIOR ART

Managing bed bug (Climes lectularius L. (Hemiptera: Cimicidae) infestation is difficult since these insects have known pesticide resistance which can allow a reduction in population but not elimination.

Insect control strips have been widely used for treating insects such as bed bugs. However, these strips are intended to be loosely hung in locations to be treated. The hung strips have a vapor that is emitted from the surface. The vapor is used as an insecticide.

Over the years it has been known to attempt to heat insecticides and pesticides to be used. Different U.S. patents generally discuss the use of lamps and heat sources to vaporize insecticides. See for example, U.S. patents: U.S. Pat. No. 2,183,187 to Rovira; U.S. Pat. No. 4,074,111 to Hunter; U.S. Pat. No. 4,171,340 to Nishimura et al.; U.S. Pat. No. 4,439,415 to Hennart et al.; U.S. Pat. No. 5,891,400 to Ansari et al.; U.S. Pat. No. 7,086,607 to Bresolin; U.S. Pat. No. 7,235,187 to Li et al.; U.S. Pat. No. 7,835,631 to Wang et al. However, these patents are not practical to being used with insecticide-impregnated strips.

Other U.S. patents include: U.S. Pat. No. 7,962,017 to Viera use a blower to generate a targeted airstream over a wick burning an insecticide. U.S. Pat. Nos. 5,335,446 and 5,566,502 each to Shigetoyo describes a room insecticide dispenser that uses a timer controlled blower with shutters to selectively release insecticide vapors. U.S. Pat. No. 4,228,124 to Kashihara et al. uses a blower to move heated air over a powdered insecticide.

U.S. Pat. No. 3,290,112 to Gillenwater et al. and U.S. Pat. No. 3,793,763 to Griffin each uses a blower to pass heated air over insecticide pellets; U.S. Pat. No. 2,390,843 to McCauley heats a liquid insecticide and uses a blower to disperse the vapor. U.S. Patent Application Publication 2008/0271338 to Muir et al. describes a blower device that can emit heated insecticides onto a surface.

However, none of these references are capable of or are practical to being used with insecticide-impregnated strips to treat pesticide resistant insects such as bed bugs.

The inventors have tested some insect impregnated strips and tried heating those strips by positioning strips in front of a standalone box fan and an oil-filled electric space heater. The space heater was positioned approximately 1 to 1½ feet from the strips, and the box fan was positioned about 1 foot behind the heater. The researchers believed that heating the room may also positively affect insecticide strips. This original research required vacant rooms and buildings be treated. The rooms and buildings would also have to be vacant for aerations times. Without the oil-filled electric heater and box fan, total bed bug mortality occurred over seven days, with just the fans total mortality occurred in 3 days, and with both the oil-filled electric heater and box fan, total mortality occurred over 36 hours.

Such a time period would be impractical in the field for professionals such as exterminators and for end-users. For example, it would be highly undesirable for a family to have to move out of a space for several days or more. The general research was discussed in broad terms at an insecticide symposium in May 2010. The research became a publication entitled: Control of Cimex Lectularius using Heat Combined with Dichlorvos Resin Strips in March 2011. However, no practical type devices or systems or methods were contemplated or discussed at that time.

Thus, the need exists for solutions to the above problems with the prior art.

### SUMMARY OF THE INVENTION

A primary objective of the present invention is to provide devices, apparatus, systems and methods of volatizing insecticides impregnated into resin strips, that are sandwiched between heating elements/plates in a single housing to treat a space for bed bugs and other insects.

A secondary objective of the present invention is to provide devices, apparatus, systems and methods of volatizing insecticides impregnated into resin strips to treat and clear a closed space for bed bugs and other insects within approximately 24 to approximately 36 hours.

A third objective of the present invention is to provide devices, apparatus, systems and methods of volatizing insecticides impregnated into resin strips to treat a space for bed bugs and other insects within approximately 6 hours, and hold the treated space for up to approximately 6 hours and aerate (vacate) the space for up to approximately 12-24 hours.

A fourth objective of the present invention is to provide devices, apparatus, systems and methods of volatizing insecticides impregnated into resin strips to treat a space for bed bugs and other insects that can be easily operated by end-users and professionals.

A fifth objective of the present invention is to provide devices, apparatus, systems and methods of volatizing insecticides impregnated into resin strips to treat a space for bed bugs using a volatile chemical that bed bugs that are not resistant to.

A novel insect treatment device can include a central chamber for supporting at least one strip impregnated with an insecticide, the central housing having a first side and a second side and top opening, a first electrically powered heating member adjacent to the first side of the central housing, a second electrically powered heating member adjacent to the second side of the central housing, and a housing for holding the central chamber and the first heating member and the second heating member together, wherein operating the first heating member and the second heating member causes the volatile-impregnated strip to exhaust volatile pesticide to flow from the top opening into a space to be treated for insect infestation.

The insect infestation can include bed bugs and other insects.

The central chamber can include a metal cage for separating the strip from directly contacting inner sides of the first heating member and the second heating member.

The first and the second heating member can each includes heating elements.

The treatment device can further include a first blower adjacent to the first heating element, and a second blower adjacent to the second heating element.

The first and the second heating member can each include heating plates.

The first and the second heating member can each include heating grills.

The treatment device can further include a temperature sensor for sensing temperature inside the central chamber, a temperature controller for heating temperatures in the central chamber between approximately 100° C. and approximately 140° C., and a timer for turning the insect treatment device on and off. Preferably the temperature controller can heat the temperature to approximately 120° C.

The insecticide impregnated-strip can include at least one dichlorvos resin strip.

A novel method of treating a closed insect-infested space with a volatilized insecticide, can include the steps of heating an insecticide-impregnated member with a heater for volatilizing the insecticide in the impregnated member to emit a volatile as an insecticide vapor into the closed space to kill insects for a first time period, turning off the heater for a second time period, and aerating the closed space for a third time period, wherein the first time period and the second time period and the third time period total approximately 24 to approximately 36 hours.

The heating step can include the step of volatilizing insecticide in the space with approximately 6 hours.

The heating step can further include the step of simultaneously running a circulating fan to distribute the volatile throughout closed space being treated.

The turning off step can include the steps of turning off the heater for approximately 6 hours, and turning off the circulating fans between approximately 10 to approximately 15 minutes after the heater to avoid overheating the insecticide-impregnated strips.

The aerating step can include the steps of moving fresh outdoor air into the space and exhausting volatile from the space with at least one fan.

The moving and the exhausting steps can include the step of circulating outdoor air and exhausting the volatile for approximately 12 to approximately 24 hours.

The heating step can include heating temperatures between approximately 100° C. and approximately 120° C.

The heating step can include sandwiching the insecticide-impregnated strip between two heating members. The heating members can be heating plates or elements.

The method can include treating bed bugs.

The heating step can include the step of heating the insecticide-impregnated member between approximately 100° C. to approximately 140° C., and preferably approximately 120° C.

A novel insect treatment system can include an insecticide-impregnated member, an electrical heater having a chamber for holding the insecticide impregnated member therein, and an air circulating fan, wherein the heater with the insecticide-impregnated member is placed within a closed empty space to be treated for insect infestation, and the heater is used for heating the insecticide-impregnated member for volatilizing the insecticide in the impregnated member to emit a volatile as an insecticide vapor while continuously running the fan in the closed empty space to kill insects and return the closed empty space to occupancy all within approximately 24 to approximately 36 hours.

The system cam include a first heat treatment stage where the fan and heater run for approximately 6 hours.

The system can include a second holding stage where the heater is turned off for six hours and the fan continues to run for approximately 10 to approximately 15 minutes.

The system can include a third aeration stage which can run between approximately 12 to approximately 24 hours where outdoor air is circulated into the closed empty space, and the volatile is exhausted out of the closed empty space.

The system heater can include two heating members that sandwich an insecticide-impregnated strip therebetween. The heating members can be heating plates, heating elements.

The insects treated by the system can include bed bugs.

The insecticide-impregnated member can include at least one dichlorvos resin strip.

The system can include a metal cage between the two heating members holding the insecticide-impregnated member.

The system heater can heat the insecticide-impregnated member between approximately 100° C. to approximately 140° C., and preferably to approximately 120° C.

Further objects and advantages of this invention will be apparent from the following detailed description of the presently preferred embodiments which are illustrated schematically in the accompanying drawings.

### BRIEF DESCRIPTION OF THE FIGURES

FIG. 1 is a perspective view of an embodiment of a bed bug control device using blowers and heated insecticides.

FIG. 2 is a cross-sectional view of the embodiment of FIG. 1 along arrow 2X.

FIG. 3 shows a room layout of using the bed bug control device of FIGS. 1-2 along with an additional room air circulation.

FIG. 4 is a graph showing the amounts of dichlorvos being vaporized over time for various heating applications according to the invention.

FIG. 5 is a graph of the mortality rate for the bed bugs over hours of treatment.

FIG. 6 is a perspective view of bed bug control device using heated plates on both sides of a housing holding volatile impregnated strip(s) along with control components.

FIG. 7 is an exploded view of the cage and spacers used for the heated plates of FIG. 6.

FIG. 8 is a top view of the bed bug control device in a single housing.

FIG. 9 is the three stage flow chart for treating closed spaces with the invention.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

A listing of components will now be described.
1. Blower(s) with strip insect treatment device
10. First (left) fan housing
11. left side intake grill
12. first blower
13. right side outlet grill
14. first heating element housing
15. first heating element
20. Second (right) fan housing
21. right side intake grill
22. second blower
23. left side outlet grill
24. second heating element housing
25. second heating element
30. volatile pesticide-impregnated strip housing
33. upper exhaust outlet
35. volatile pesticide-impregnated strip
40. ceiling fan
50. portable fan
100. heated plates sandwich with center strip insect treatment (modified waffle) device
110. first heated plate (left plate)
120. second heated plate (right plate)
130. volatile pesticide-impregnated strip cage housing
132. closed end wall spacer
138. closed end wall spacer
140. volatile pesticide-impregnated strip(s)
142. first strip
146. second strip
150. thermocouple
152. thermocouple wire
160. temperature controller
162. plate power wire
164. plate power wire
166. power supply wire
170. solid state relay
172. signal wire
180. timer
200. Single housing for hot plate heater
   Heating Elements (Toaster Version) with Blower(s) & Insecticide Strip

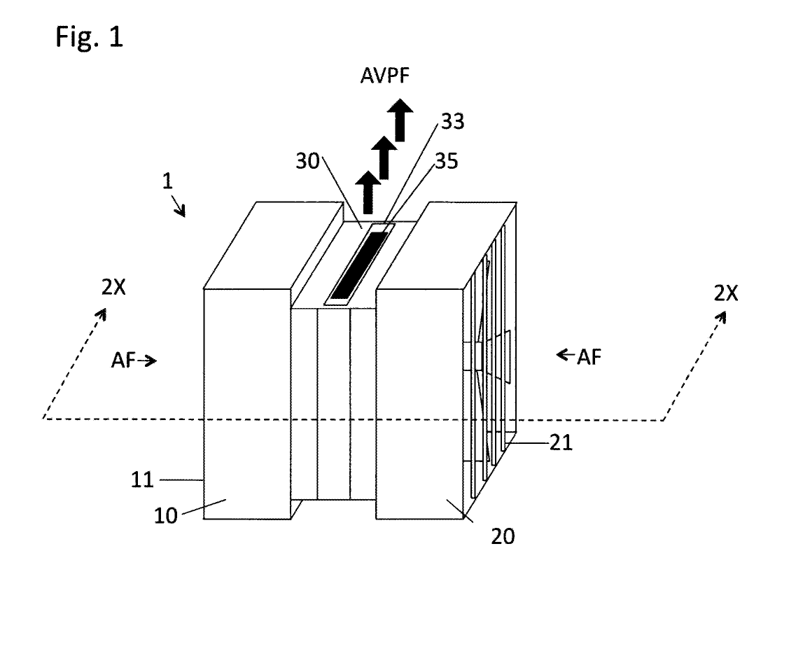

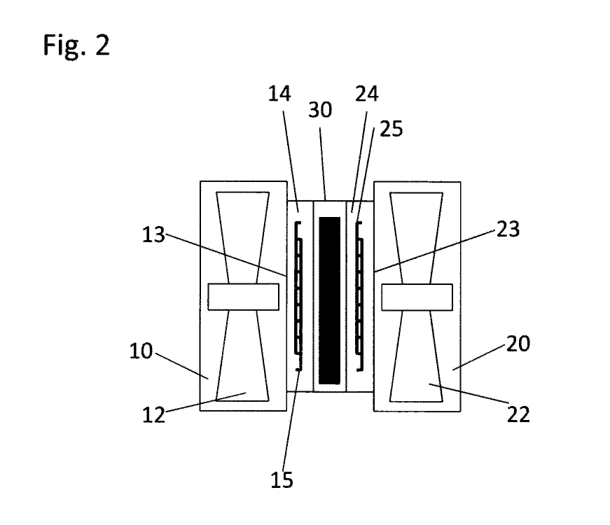

FIG. 1 is a perspective view of a preferred embodiment of a bed bug control device 1 using blowers 12, 22 and heated insecticide strip 35. FIG. 2 is a cross-sectional view of the embodiment of FIG. 1 along arrow 2X.

Referring to FIGS. 1-2, a preferred embodiment of the device 1 can include a left fan housing 10 and a right fan housing 20, with each of the fan housings 10, 20 containing a separate blower/fan 12, 22. The fans/blowers 12, 22 can be electrical powered fans. On the inner side of the left fan housing 10 can be a first heater housing 14 containing a first heater element 15. The heater elements 15, 25 can be electrical heating elements such as heated wires, and the like. On the inner side of the right fan housing 20 can be a second heater housing 24 containing a second heater element 25. Sandwiched between the two heater housings 10, can be a pesticide holding housing 30 that can contain at least one volatile pesticide impregnated strip 35.

In operation the fans/blowers 12, 22 can move air from the outer sides (intake grills) 11, 21 of the left and right fan housings 10, 20 toward inner grills 13, 23 into the respective heating element housings 24, 26 through the inner located heating elements 15, 25 and against the sides of the pesticide impregnated strip(s) 35 that is located inside of strip housing 30. The heated air with volatile pesticide flows upward outside of an outlet 33 of the strip housing 30, where it can be dispersed into a room.

The heating elements 15, 25 effectively can heat the air blowing onto the strip(s) 35 to exhaust from the device 1 at temperatures between approximately 100° C. to approximately 140° C. (and preferably at approximately 120° C.). The blowers/fans 12, 22 and heating elements 15, 25 should be operated so as not to accumulate extra heat in the room to be treated, so that the room temperature remains ambient at between approximately 22° C. to approximately 25° C.

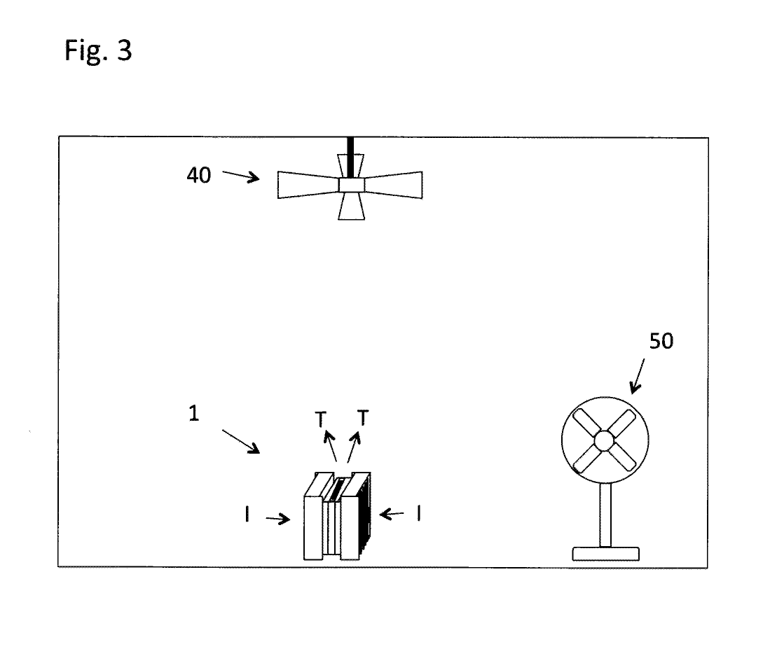

FIG. 3 shows a room layout of using the bed bug control device 1 of FIGS. 1-2 along with at least one additional room air circulator(s) 40/50 that can include either or both a ceiling fan 40 and/or portable fan 50. The novel device 1 can additionally use a circulating fan (ceiling fan 40 or portable fan 50) to move and circulate air into the room. The invention does not allow for using HVAC (heating ventilation and cooling) systems, since they often rely on circulating outside air into the room.

The invention can be practiced with one or more strips 35 as per the room size to be treated. For example, a strip 35 having a rating of treating a room space of approximately 900 to 1200 cubic feet, can use two strips for treating a room space of between 1800 to 2400 cubic feet. Additional strips can be used as needed for larger room spaces to be treated.

While the preferred embodiment shows two separate blowers/fans 12, 22, the invention can be practiced with a single blower/fan 12 which has an outlet the splits airflow to both sides of the impregnated strip.

The inventors have performed tests on the bed bug, Cimex lectularius L. (Hemiptera:Cimicidae), and evaluated the effects of heat with air circulation on the efficacy of dichlorvos resin strips in the control of bed bugs. Treatments were performed in unoccupied dormitory rooms and consisted of dichlorvos resin strips containing 18.6% active ingredient. The mortality of bed bugs and weight loss of the dichlorvos strips were evaluated over 7 days. Dichlorvos resin strips killed bed bugs and eggs in just over 7 days. The addition of the fan and heat decreased time to 100% mortality at approximately 36 hours. Eggs located in treated rooms did not hatch. Resin strips in the strips plus fan plus heat treatment volatized 70 times faster than strips in the strips only treatment. The addition of heat in treatments with dichlorvos resin strips enhances the overall efficacy of the volatile insecticide and reduces the time required to eliminate live bed bugs and eggs.

### Testing Modified Toasters as Heaters for Dichlorvos Strips

The testing involved taking an off the shelf bread toaster. Two double slice bread toasters (Model 22605, Hamilton Beach, Southern Pines, N.C.) were converted to heat dichlorvos strips and increase volatilization of the active ingredient. The carriage-release mechanism was disabled so heat would be generated constantly.

A cage was fabricated with wire mesh to hold the dichlorvos strips in the toast slots and between the heating coils. Two modified heaters were used per apartment. The heaters were placed on their sides a wooden platform approximately 30 cm above the finished floor. Desk fans (27 cm in diameter, Kaz incorporated, Southborough, Mass.) were placed directly behind the heater and set on high speed to push volatiles out of the strip while preventing strips from overheating. The heaters were located in the corners of a living room and the bedroom.

Placement of Fans with Modified Toasters in an Apartment

Placement of circulating fans and other elements were done with the heaters in an apartment. Box fans (51 cm in diameter, Lasko Products, West Chester, Pa.) were placed immediately behind the heater stand to drive dichlorvos vapor toward the center of either the living room or the bedroom. A third box fan was placed so that it pushed dichlorvos vapor into the kitchen. Oscillating fans (model 0029180, 60 cm in diameter, Utilitech, U.S.A.) were placed in the center of the living room and at the foot of the bed in the bedroom to circulate the air toward the ceiling and increase dichlorvos volatilization and distribution within the treated structure. All fans used for air circulation were turned on the lowest fan speed.

### Dichlorvos Resin Strips and Treatment Applications

NUVAN® PROSTRIPS® Plus (EPA Reg. No. 5481-554, American Vanguard Corporation, AMVAC, Los Angeles, Calif.) with 18.6% of dichlorvos were used in all replicates. Each strip (approximately 65 g) contained approximately 12 g of dichlorvos.

Before each experiment, the apartment air-handling system was disabled, windows and doors were closed, and any cracks or other large openings were sealed with painters tape. Apartments were treated with 1, 2, 3, or 4 strips that were placed in 2 modified heaters per apartment. For the 1 and 3 strip rates, a dichlorvos strip was cut in half, and each half was placed within each room in a separate modified heater. Treatment was done by heating strips for 6 h in closed apartment. At least three replicates were conducted for each treatment.

Resin strip weights were recorded, and bed bug mortality was evaluated by hour during the 6-hour treatment. Bed bug mortality was visually checked without opening the covered vials and controls. After the 6-hour treatment, the heaters were turned off, the strips were re-weighed, and the vials with bed bugs were removed from the treatment site. A final mortality determination was done 12-hour after treatment initiation, or 6-hour after the end of the treatment. Bed bugs that were not able to right themselves were counted as dead.

### Aeration

After the dichlorvos treatment was complete at 6 hours, all windows and doors were opened and the oscillating fans were repositioned to pull air into the bedroom window and exhaust it through the front door for at least 48 hours after each replicate. The box fan at the kitchen entrance was repositioned to exhaust air from the kitchen into the living room area. The other box and desk fans were not repositioned.

### Data Analysis

Mortality (%) data was arcsine transformed before analysis. The number of bed bugs killed (% mortality) and the average time for bed bug mortality (mean time to death) was analyzed by analysis of variance (ANOVA) with the main effects as treatment (# of strips/apartment), vial covering (open or cloth-covered), and location (vial placement inside the apartment). When significant effects were obtained in ANOVA, differences between treatment means were compared using Fisher's protected least significant differences (LSD) test (≦0.05; JMP Student Edition, Version 9.0 (SAS Institute, INC., Cary, N.C.).

### Mean Time to Death

Bed bug death after being exposed to NUVAN® PROSTRIPS® was affected by the number of strips per apartment (df=2, F=3.78, p=0.0267), vial covering (df=1, F=244.55, p<0.0001), and location (df=5, F=5.15, p=0.0004). There was no control mortality. The average time to bed bug death (4-h) after exposure to 4 Nuvan Prostrips was significantly shorter than the average time to death for bed bugs that were exposed to 2 dichlorvos strips (4.9 hours). The mean time to bed bug death was significantly shorter in open vials (2-hours) than cloth-covered vials (6.6 hours) The bed bugs in vials placed in the apartment kitchen and closet required a significantly longer exposure time to die than bed bugs in vials that were placed on the desk, headboard, and dresser. The mean time to bed bug death decreased in open vials as the number of strips used per apartment increased. The mean time to bed bug death was significantly lower in open vials than cloth-covered vials for all treatments.

### 6-H Bed Bug Mortality.

Bed bug mortality after being exposed to NUVAN® PROSTRIPS® for 6 hours was significantly affected by the number of strips per apartment (df=3, F=19.87, p<0.0001), vial covering (df=1, F=280.18, p<0.0001), and vial location (df=5, F=4.71, p=0.0006). The interaction of the number of strips and vial covering was significant (df=3, F=10.35, p<0.0001). The interaction of the number of strips and vial location was also significant (df=15, F=2.07, p=0.0165). There was no control mortality. There were no significant differences in the mortality of bed bugs exposed to 3 or 4 strips; however, significance in mortality was observed between the remaining treatments.

Bed bugs exposed to 4 NUVAN® PROSTRIPS® reached 82% mortality after 6-hours, while 50% of bed bugs died after 6 hours exposure to 1 strip. Mortality of bed bugs in open vials (96%) was significantly higher than those held in cloth-covered vials (44%) after 6 hours exposure to dichlorvos. Bed bugs that were exposed to dichlorvos in the closet and kitchen had significantly lower mortality than bed bugs exposed to dichlorvos at the headboard and dresser. Of all 6 locations, bed bugs in the kitchen had the least mortality (55%), which was significantly different than all other locations except the closet (64%). Bed bugs attached to the headboard in the bedroom had the greatest mortality (81%) of all locations after 6 hours of exposure to NUVAN® PROSTRIPS®.

### 12-H Bed Bug Mortality.

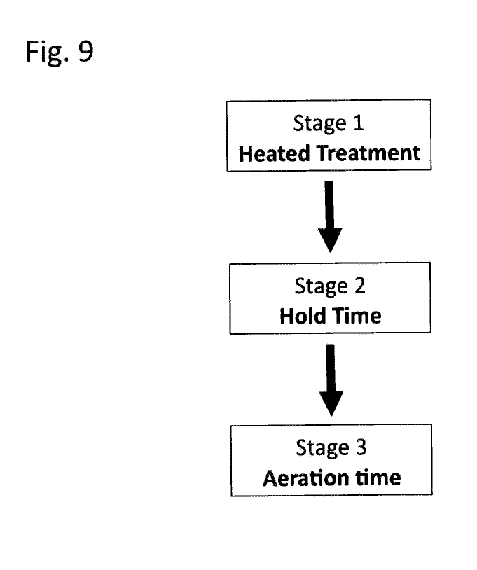

Bed bug mortality at 12 h after the start of the experiment was significantly affected by the number of strips per apartment (df=3, F=102.59, p<0.0001), vial covering (df=1, F=72.43, p<0.001), and their interaction (df=3, F=69.65, p=<0.0005. Total bed bug mortality (100%) was reached at 12 h when exposed to 2, 3, or 4 NUVAN® PROSTRIPS®. Treatments using 1 NUVAN® PROSTRIPS® resulted in 69% bed bug mortality. Bed bugs held in open vials reached 99% mortality after 12 hours while only 87% of bed bugs died when held in cloth covered vials (FIG. 3-18).

The use of dichlorvos impregnated resin strips combined with heat is known to the inventors. See for example, Makara, G. 1973. Chlorphenamidine as an ovicide and the efficiency of heat in killing lice and nits. Proceedings of the International Symposium on the control of lice and louse-borne diseases. 263:198-200. See also Lehnert, M. P., R. M. Pereira, P. G Koehler, W. Walker, and M. S. Lehnert. 2011. Control of Cimex lectularius using heat combined with dichlorvos resin strips. J. Med. Vet. Entomol. 25: 460-464.

However, the novel application method used in this experiment localizes the increased temperature into a compact heater so that only the dichlorvos strips are heated.

Although high temperatures increase insect metabolism and respiration, results from a previous study showed a negative temperature-toxicity correlation between dichlorvos vapor and bed bug mortality, which led to this modification of a previous study reported. See for example, Lehnert, M. P., R. M. Pereira, P. G Koehler, W. Walker, and M. S. Lehnert. 2011. Control of Cimex lectularius using heat combined with dichlorvos resin strips. J. Med. Vet. Entomol. 25: 460-464.

Because field applications of dichlorvos resin strips require that air handling systems be disabled, the ambient temperature inside the apartments were not monitored or manipulated to simulate real-world treatment conditions. The combination of 2 NUVAN® PROTRIPS® (65 g) hung on a polyvinyl chloride (PVC) stand approximately 15 cm from an oil-filled electric space heater+1 box fan (approximately 51 cm in diameter increased the efficacy of dichlorvos applications and volatilized DDVP 70 times faster than using the strips alone, resulting in 100% bed bug mortality after 36 hours. See for example, Lehnert, M. P., R. M. Pereira, P. G Koehler, W. Walker, and M. S. Lehnert. 2011. Control of Cimex lectularius using heat combined with dichlorvos resin strips. J. Med. Vet. Entomol. 25: 460-464.

However, the results of the current investigation indicate a decrease in the dichlorvos exposure time needed to eliminate bed bugs held in open and cloth-covered vials to 6 h with the addition of localized heating of NUVAN® PROSTRIPS® and increased air circulation.

Use of compact heaters that rapidly release dichlorvos vapor from impregnated resin strips in combination with air circulation decreases the exposure and treatment time necessary for bed bug control. However, dichlorvos takes time to pass through the cloth into the air space of the vials containing bed bugs, resulting in increased exposure that might not occur in practical bed bug treatments. Studies conducted after this experiment verified increased survival after 12 hour mortality counts when bed bugs were removed from the apartment and placed in clean petri-dishes directly following the 6 h exposure period.

According to the NUVAN® PROSTRIPS® label, four (65 g) dichlorvos strips are necessary to eradicate bed bugs in the apartment used during this investigation (volume of 118 m³). In this study, there was no difference in mortality after 12 h when bed bugs were exposed to 2, 3, or 4 strips, which is ½ to full label dose.

Bed bugs exposed to DDVP in the kitchen and bedroom closet resulted in either increased survivorship or slower death than bed bugs located in all other areas, suggesting unequal dichlorvos distribution in the treated structure.

The fan placement and settings used in this experiment were chosen based on preliminary studies. The highest air circulation speed on the desk fans were required to minimize burning of the NUVAN® PROSTRIPS®. When dichlorvos treatment was applied with the desk fans on the lowest setting, the temperature increased and melted the dichlorvos strip.

The lowest fan speed was used on the box fans placed directly behind the heater stands. Preliminary tests with the box fans set at the highest speed resulted in decreased weight loss per strip. These observations indicate that the heater temperature, the fans used to push dichlorvos out of the strip, and fans used to circulate air throughout the treatment area are critical to optimize the efficacy of NUVAN® PROSTRIPS® for bed bug control. Variations in resin strip weight loss and bed bug mortality due to speed changes in the oscillating fan (located in living room and bedroom) that circulated dichlorvos-rich air toward the ceiling were not investigated; however, based on our observations, it is likely that slightly decreased air circulation will result in increased bed bug mortality.

The aeration time after dichlorvos treatment between replicates was at least 48 hours. Two preliminary experiments with aeration time of approximately 8-12 hours resulted in the bedroom closet having the most rapid bed bug death. The faster kill in the bedroom closet was interpreted to be the result of persistent dichlorvos vapors.

The efficacy and time of treatment are both enhanced by using a method that rapidly releases dichlorvos strip vapor using localized heating source. Heating dichlorvos resin strips increases the active ingredient dose in air.

Waffle Iron Modified Heater with Dichlorvos Strips

For testing, a Black & Decker® waffle iron Model No. G48TD having dimensions of 13.0 by 13.63 by 6.38 inches, weighing approximately 7.95 pounds and having a wattage of approximately 900 Watts was used. For the testing, the top and the bottom parts were separated to accommodate the “cage” where we placed the insecticide strips. We used the “heated-plate heater” in the upright position, so both plates were vertical on both sides of the insecticide strip which was “sandwiched” between the heated plates within the wire cage.

Initial tests were conducted in which the temperature in the heated-plate heater was controlled by limiting the power supply to the heater, by using a rheostat. Further temperature control was obtained by placing a fan directly behind the upright heater. Later, we incorporated a temperature controller 160 and a solid state relay 170 so a maximum temperature (120° C.) could be set. Temperature inside the heated-plate heater, at the level of the Nuvan Strips, was 120° C. as measured by a K thermocouple (150, 152) that cause the temperature controller to shut off the heaters when the temperature exceeded the maximum set point.

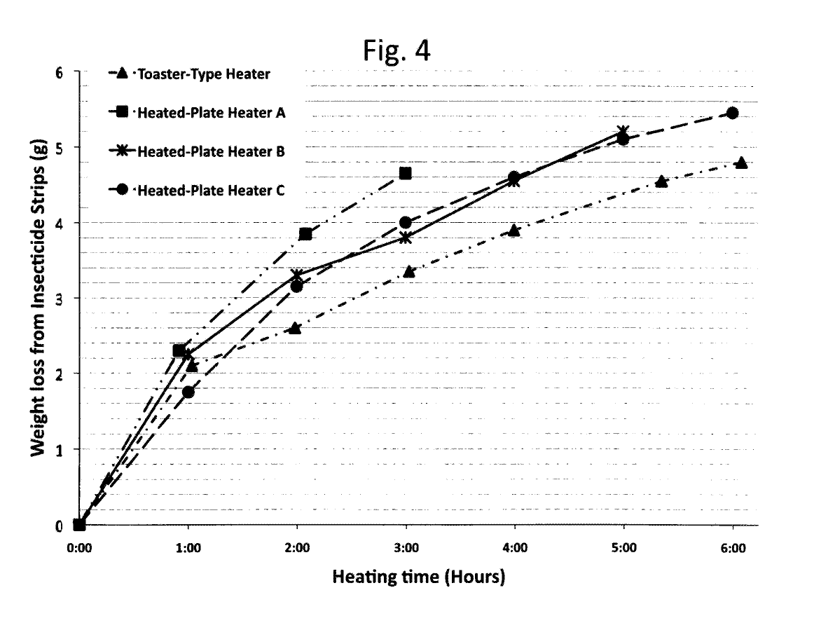

FIG. 4 is a graph showing the amounts of dichlorvos being vaporized over time for various tested heating applications according to the invention that included the modified toaster-type heater referenced above and a modified heated-plate heater (modified waffle iron) in 3 different versions (marked as A, B, and C in FIG. 4) which produced adequate and similar results with greater than 5 g of the volatile insecticide volatilizing from each Nuvan ProStrip.

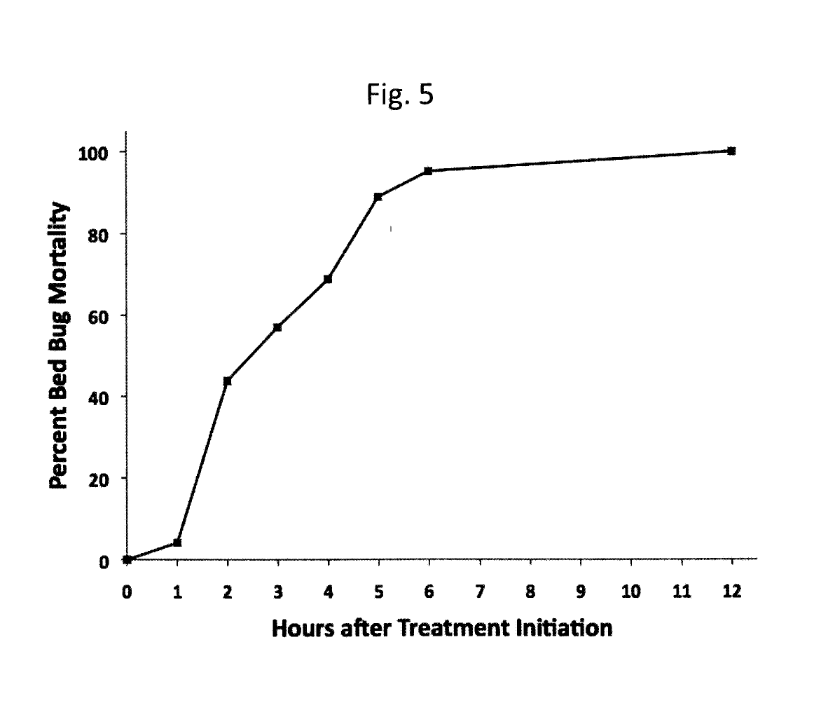

Our standard was the Toaster-type Heater, which we used in the experiment that generated the mortality curve in the next graph shown in FIG. 5, using the optimum dose of 4 strips in the test apartments. Those results showed that a weight loss in the strip of approximately 5 g or more in 6 hours causes adequate insect mortality.

With the modified waffle iron heated-plate type heater we achieved higher levels of weight loss in the insecticide strips than the minimum we were looking for. The different lines for the Heated-plate Heater represent different trials with minor modification in either power (wattage) level or insecticide strip placement.

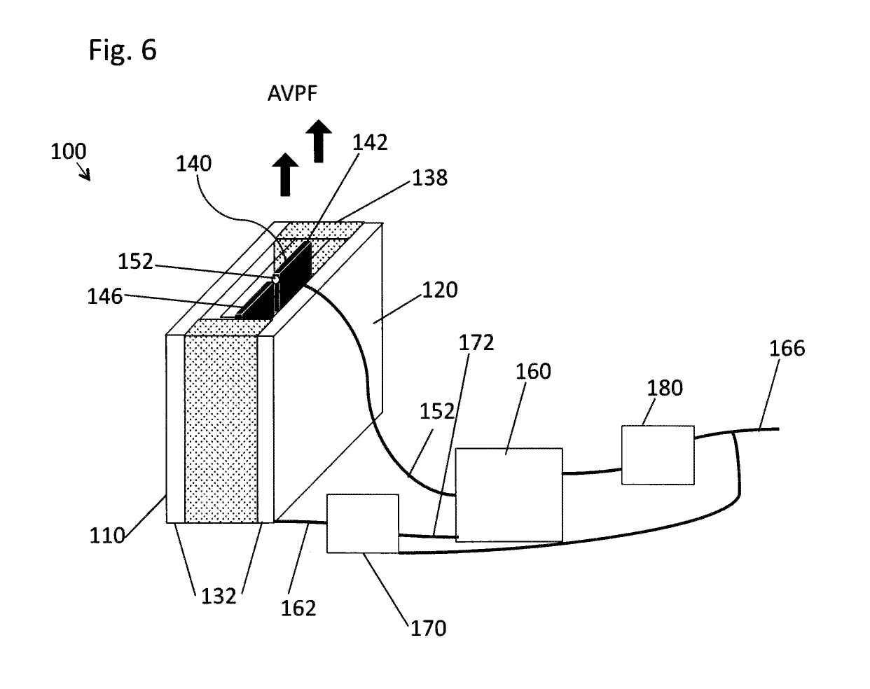

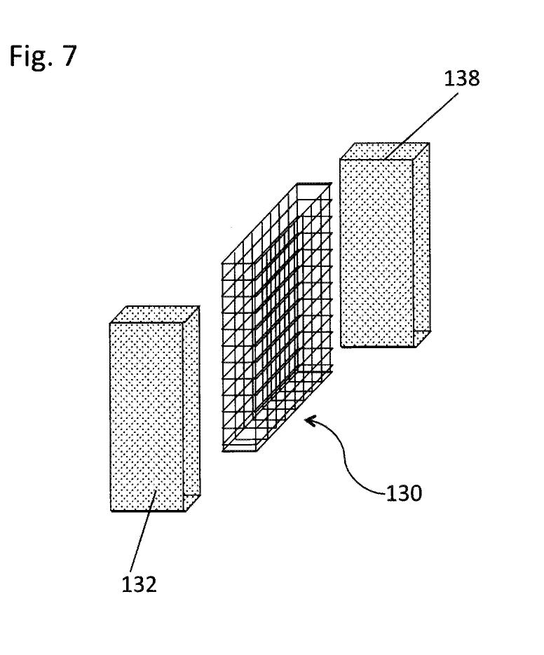

HEATER A was constructed by using 2 laboratory hot plates as the heated plates, which were set at 300 Watt of power. Sides of the heater area between plates were not sealed with spacers as seen in FIG. 6 and FIG. 7.

HEATER B, consisted of a modified Dazey® Short Order Chef Waffle Maker which was run with only 55% of its normal 1000 Watt power. The Dazey® Short Order Chef Waffle Maker is essentially the same appliance as the Black & Decker® waffle iron described above, but with higher power (1000 Watt) heater than the Black & Decker® waffle iron (900 Watt). Sides of the heater area between plates were not sealed with spacers as seen in FIG. 6 and FIG. 7. HEATER C Was similar to the Heater B but placed in the test apartment mentioned in previous experiments and with fans placed behind the appliance. The sides of the heated chamber were sealed in this test to enhance chimney effect.

After testing was completed it was determined that the Heated-plate Heater (modified waffle iron) had superior results over the modified toaster-type Heater because we get better volatilization of the insecticide, with better temperature control in the heater, which avoids overheating that can lead to burns in the insecticide strip, and degradation of the insecticide. If the insecticide is degraded by the heater, or the insecticide strip is burned, the weight loss does not represent a true amount of insecticide available to kill the bed bugs in the room being treated.

FIG. 5 is a graph of the mortality rate for the bed bugs over hours of treatment using the modified toaster heater. This graph represents the mortality of bed bugs placed in several locations in a 1-bedroom apartment treated with 4 insecticide strips (label rate for the size of apartment) using the modified toaster-type heater to volatilize the insecticide from the strips. Bed bugs were place in vial either covered with double layer of cloth, or in vials left open, to represent different levels of protection from bed bugs would have in real life situations. Bed bugs were placed in 7 locations in the apartment. The bed bugs were removed from the treated apartment after 6 hours of exposure to the insecticide.

All bed bugs were dead 12 hours after initiation of the treatment (with only 6 hours of exposure to the insecticide-treated environment in the apartment.

FIG. 6 is a perspective view of a bed bug control device 100 using heated plates 110, 120 on both sides of a housing 130 holding volatile impregnated strip(s) 140. A main benefit of the heated plates is to have a uniform heating of the strips, so there is no burning, and a high level of insecticide volatilization is obtained. By having the heated plates, we avoid the exposure of the very hot heating elements that could degrade the insecticide if the air with insecticide is circulated through the heating elements.

FIG. 7 is an exploded view of the wire mesh strip holder cage 130 and end wall spacers 132, 138 used between the heated plates 110, 120 of FIG. 6. The side spacers 132 can be made of concrete or plaster, and the cage 130 can be a galvanized wire mesh (0.25 to 0.5 inch space between wires). The cage 130 is embedded (anchored) into the plaster spacers 132, 138. The cage 130 can be 0.5 in thick, and about 7 inches by 7 inches in size. The spacers 132, 138 can be about 0.25 inch (on each side) wider than the wire cage 130. The insecticide strips 140 can be placed into and vertically oriented in the cage 130 where the cage can be separated from each of the plates 110, 120 by approximately 0.25 inches.

Referring to FIGS. 6-7, a first (left) heated plate 110 and second heated plate 120 on both sides of a central housing 130 that can support volatile impregnated strip(s) 140. The heated plates 110 and 120 can be those used in the Black & Decker® waffle iron Model No. G48TD. Types of heated plates and heating grids and related components can also be those found in U.S. Pat. No. 5,636,564 to Weiss and U.S. Pat. No. 6,427,581 to Wu, and U.S. Published Patent Application 2006/0201333 to Friel, Sr. et al., which are all incorporated by reference.

The insecticide-impregnated strips 140, 142, 144 can be dichlorvos-impregnated resin strips such as those from NUVAN PROSTRIPS® by Amvac-Chemical, described above.

Thermocouple 152 can a K thermocouple that can measure temperatures between 0° C. and approximately 150° C. or 32° F. to approximately 300° F., such as the Omega Compact Transition Joint Probes, model TJC36 series.

The temperature controller 160 can include 1/32 DIN Ramp/Soak Controllers by Omega model no. CN7500 Series, which inputs from a thermocoupler.

The solid state relay 170 can include the SSRL Series solid state relay by Omega, model no. SSRL240AC10 that is used to control large resistance heaters in conjunction with temperature controllers.

The timer 180 can include a Utiltech digital 8-outlet power strip timer Model TE08WHBL

The operation of the heater plate embodiment 100 will now be described. Power can be supplied from a house power supply such as 120 volts connects to Timer 180 and Solid State Relay 170. Timer controls when the heater 100 is turned on and when it is turned off. The timer 180 can also control a fan which is integrated or not to the heater 100. A preferred time for the heater 100 to be on is approximately 6 hours.

During operation fans integrated with the heater 100 or other circulating fans should stay on for approximately 10 minutes longer than the heater 100 to allow the heater 100 to cool down without causing the strips 140 to burn. Power goes to the temperature controller 160 which is set with a maximum temperature of approximately 120° C.

The temperature controller 160 maintains the temperature right at (or very close to the set temperature. Temperature can be measured at the level of the strips 140 inside the heater 100 by a thermocouple 152. When the temperature controller 160 calls for the heating elements/plates 142, 144 to be on, a signal is passed to the solid state Relay 170. The relay 170 closes the circuit and allows power to go to the heating elements/plates 142, 144 so the elements/plates 142, 144 can be heated.

Heating the strips 142, 144 releases a volatile pesticide flow upward from the heater 100 in a chimney effect. As previously described, additional fans can circulate the volatized air into the sealed unit to be treated.

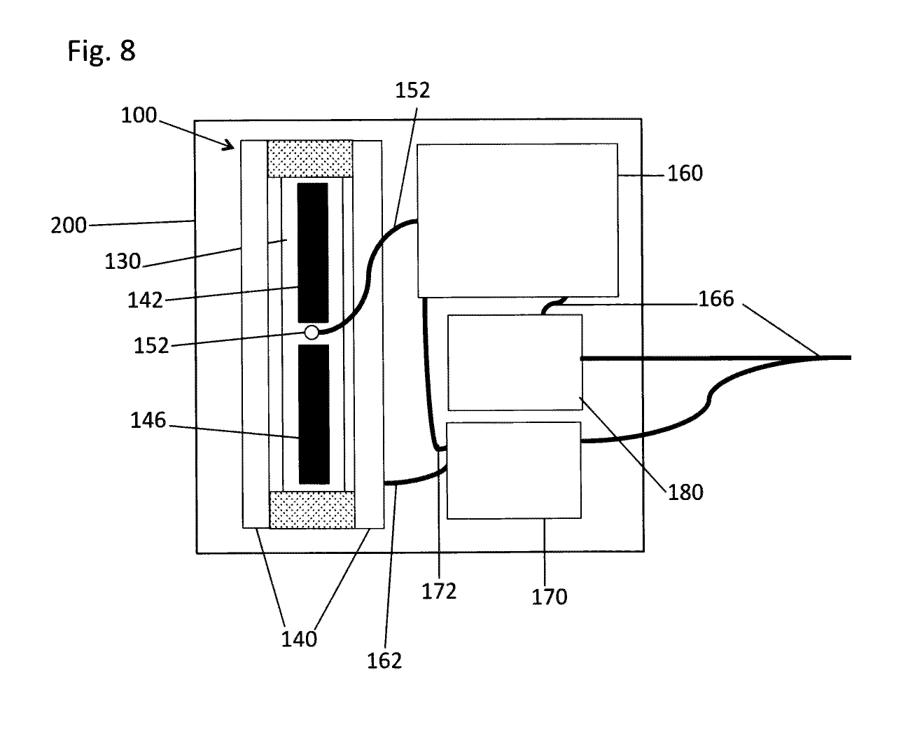

FIG. 8 is a top view of the bed bug control device 100 and related components of FIGS. 6-7 in a single compact housing 200, which can be approximately 10 by approximately 10 by approximately 10 inches. The single housing 200 allows all components to be contained within a single compartment to facilitate wiring, decrease any chances of damage to wiring and other components, and provides a single appliance for the pest management professional to carry and use when setting up the equipment for control of bed bugs and other insects.

A preferred version of the novel method can include three Treatment Stages for treating single units from start to finish where occupants can return to the units within approximately 24 to approximately 36 hours. The unit being treated can be a house, apartment, building or other structures with separate rooms, single-room structures, or single rooms within structures. Windows, exterior doors and any other opening that would allow escape of the volatile insecticide should be sealed during the treatment.

For stage 1—Heated Treatment—, after the unit space has been closed (sealed) and the heater and fans are turned on, Heating Time can run up to 6 hours (with insecticide volatilization occurring for approximately full 6 hours) while circulating fans (industrial fan, box fan, circulating fan) are used to distribute the volatile insecticide throughout the closed space being treated.

For stage 2—Hold Time—, the heaters and fans can be turned off while the space unit is still closed (sealed) for approximately 6 hours. Although not preferred, depending on the space being treated and the contents of the treated space, circulating fans can be run for the duration, or part of the Hold Time.

For stage 3—Aeration time—, the unit space is opened up where windows and/or doors can be opened and fans can be positioned to move fresh outdoor air into the space and/or exhaust air outside of the treated space for approximately 12 hours to approximately 24 hours.

While heating elements and heating plates are described, the heating members can include other types of heating members, such as but not limited to heating grills, and the like.

Other volatile insecticides impregnated in resin, plastic, or other strips similar in size and/or composition as those of NUVAN® PROSTRIPS® can be used in similar way as dichlorvos because volatilization of these compounds can be accelerated by use of heat.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. An insect treatment device, comprising:
a central chamber for supporting at least one strip impregnated with an insecticide, the central housing having a first side and a second side and top opening;
a first electrically powered heating member adjacent to the first side of the central housing;
a second electrically powered heating member adjacent to the second side of the central housing; and
a housing for holding the central chamber and the first heating member and the second heating member together, wherein the central chamber supporting the at least one insecticide impregnated strip and the first heating member and the second heating member are adapted to be placed within a closed empty space to be treated for insect infestation, wherein operating the first heating member and the second heating member causes the volatile-impregnated strip to exhaust volatile pesticide to flow from the top opening into the closed space to be treated for insect infestation.

2. The insect treatment device of claim 1, wherein the insect infestation includes: bed bugs and other insects.

3. The insect treatment device of claim 1, wherein the central chamber includes:
a metal cage for separating the strip from directly contacting inner sides of the first heating member and the second heating member.

4. The insect treatment device of claim 1, wherein the first and the second heating member each includes heating elements.

5. The insect treatment device of claim 4, further comprising:
a first blower adjacent to the first heating element; and
a second blower adjacent to the second heating element.

6. The insect treatment device of claim 1, wherein the first and the second heating member each includes heating plates.

7. The insect treatment device of claim 1, wherein the first and the second heating member each includes heating grills.

8. The insect treatment device of claim 1, further comprising:
a temperature sensor for sensing temperature inside the central chamber;
a temperature controller for heating temperatures in the central chamber between approximately 100° C. and approximately 140° C.; and
a timer for turning the insect treatment device on and off.

9. The insect treatment device of claim 8, wherein the temperature controller heats the temperature to approximately 120° C.

10. The insect treatment device of claim 1, wherein the strip includes at least one dichlorvos resin strip.

11. A method of treating a closed insect-infested space with a volatilized insecticide, comprising the steps of:
heating an insecticide-impregnated member with a heater for volatilizing the insecticide in the impregnated member to emit a volatile as an insecticide vapor into the closed space to kill insects for a first time period;
turning off the heater for a second time period; and
aerating the closed space for a third time period, wherein the first time period and the second time period and the third time period total approximately 24 to approximately 36 hours.

12. The method of claim 11, wherein the heating step further includes the step of:
volatilizing the insecticide in the space over approximately 6 hours.

13. The method of claim 12, wherein the heating step further includes the step of:
simultaneously running a circulating fan to distribute the volatile throughout closed space being treated.

14. The method of claim 11, wherein the turning off step includes the steps of:
turning off the heater for approximately 6 hours.
turning off the circulating fans between approximately 10 to approximately 15 minutes after the heater to avoid overheating the insecticide-impregnated strips.

15. The method of claim 11, wherein the aerating step includes the steps of:
moving fresh outdoor air into the space, and
exhausting volatile from the space with at least one fan.

16. The method of claim 15, wherein the moving and the exhausting steps includes the step of:
circulating outdoor air and exhausting the volatile for approximately 12 to approximately 24 hours.

17. The method of claim 11, wherein the heating step includes the step of:
heating temperatures between approximately 100° C. and approximately 120° C.

18. The method of claim 11, wherein the heating step includes the step of:
sandwiching the insecticide-impregnated strip between two heating members.

19. The method of claim 18, wherein the two heating members include: heating plates.

20. The method of claim 18, wherein the two heating members include: heating elements.

21. The method of claim 11, wherein the insects include bed bugs.

22. The method of claim 11, wherein the heating step includes the step of:
heating the insecticide-impregnated member between approximately 100° C. to approximately 140° C.

23. The method of claim 22, wherein the heating step includes the step of:
heating the insecticide-impregnated member to approximately 120° C.

24. An insect treatment system comprising:
an insecticide-impregnated member;
an electrical heater having a chamber for holding the insecticide impregnated member therein; and
an air circulating fan, wherein the heater with the insecticide-impregnated member is placed within a closed empty space to be treated for insect infestation, and the heater is used for heating the insecticide-impregnated member for volatilizing the insecticide in the impregnated member to emit a volatile as an insecticide vapor while continuously running the fan in the closed empty space to kill insects and return the closed empty space to occupancy all within approximately 24 to approximately 36 hours.

25. The system of claim 24, wherein the system includes:
a first heat treatment stage where the fan and the heater are running for approximately 6 hours long.

26. The system of claim 25, wherein the system includes:
a second holding stage where the heater is turned off for approximately 6 hours and the fan continues to run for approximately 10 to approximately 15 minutes.

27. The system of claim 26, wherein the system includes:
a third aeration stage that runs for approximately 12 to approximately 24 hours where outdoor air is circulated into the closed empty space, and the volatile is exhausted out of the closed empty space, by at least one fan.

28. The system of claim 24, wherein the heater includes:
two heating members that sandwich an insecticide-impregnated strip therebetween.

29. The system of claim 28, wherein the two heating members include: heating plates.

30. The system of claim 28, wherein the two heating members include: heating elements.

31. The system of claim 24, wherein the insects include bed bugs.

32. The system of claim 24, wherein the insecticide-impregnated member includes:
at least one dichlorvos resin strip.

33. The system of claim 28, further comprising:
a metal cage between the two heating members for holding the insecticide-impregnated member.

34. The system of claim 24, wherein the heater heats the insecticide-impregnated member between approximately 100° C. to approximately 140° C.

35. The system of claim 34, wherein the heater heats the insecticide-impregnated member to approximately 120° C.
